(19) United States
(12) Patent Application Publication
(10) Pub. No.: US 2021/0129135 A1
(43) Pub. Date: May 6, 2021

(54) HOURGLASS SHAPED BLOOD FRACTIONATION TUBE AND SYSTEM

(71) Applicants: Nicholas Crabtree, Greenville, NC (US); Jeff Hrush, Wilmington, NC (US); Carlos Aparicio, Miami, FL (US); Adam Burke, Wilmington, NC (US)

(72) Inventors: Nicholas Crabtree, Greenville, NC (US); Jeff Hrush, Wilmington, NC (US); Carlos Aparicio, Miami, FL (US); Adam Burke, Wilmington, NC (US)

(21) Appl. No.: 17/086,370

(22) Filed: Oct. 31, 2020

Related U.S. Application Data
(60) Provisional application No. 62/929,165, filed on Nov. 1, 2019.

(51) Int. Cl. B01L 3/00; B04B 5/04

(52) U.S. Cl. CPC B01L 3/5021; B04B 5/0414; B01L 2300/042; B01L 2200/141; B01L 2300/0832

(57) ABSTRACT

An hourglass shaped blood fractionation tube is sized and shaped such that whole blood that has been centrifuged with a density gradient medium yields a PBNC layer within the narrowed neck of the tube. This orientation results in an elongated or widened PBMC layer, versus what would result in a conventional fractionation tube. Elongating or widening the PBMC layer allows technicians to harvest higher purity and higher volume PBMC samples versus samples harvested with a standard cylindrical blood fractionation tube. The hourglass shaped blood fractionation tube according to the present invention preferably includes a cap and can be used in conventional centrifuges and robotic pipetting stations.

### CROSS-REFERENCE TO RELATED APPLICATIONS

This application claims the benefit of U.S. Provisional Patent Application 62/929,165 entitled HOURGLASS SHAPED BLOOD FRACTIONATION TUBE AND SYSTEM, which was filed Nov. 1, 2019. The provisional application is incorporated in its entirety into the present application.

### BACKGROUND OF THE INVENTION

The present invention relates to disposable lab supplies, and more specifically, to a blood fractionation tube and system having a unique hourglass shape.

Blood fractionation is the process of separating whole blood into its component parts. For example, simple centrifugation is a common fractionation method that results in plasma in the upper phase, the buffy coat in the middle phase, and erythrocytes at the bottom of the centrifuge tube. This is shown in FIG. 1.

Density gradient media may be added to whole blood before centrifugation when it is desirable to isolate more specific components than is possible with simple centrifugation alone. For example, the density gradient medium FICOLL facilitates the separation of whole blood into a top layer of plasma, followed by a fraction of peripheral blood mononuclear cells (PBMCs), a fraction of polymorphonuclear cells such as neutrophils and eosinophils, and finally erythrocytes. This is shown in FIG. 2. PBMCs are peripheral blood cells having a round nuclei. This group comprises lymphocytes (T cells, B cells, NK cells) and monocytes. In humans, lymphocytes make up the majority of the PBMC population. PBMCs have clinical and research applications in a variety of disciplines including immunology, toxicology and molecular biology. Accordingly, it is often desirable to harvest pure PBMC samples from whole blood.

Harvesting a pure sample of isolated PBMC from a standard blood fractionation tube is difficult because the PBMC layer is relatively thin and the borders are not always clearly distinguishable to the human eye, so pipetting and the like often compromises a sample and results in low PBMC recovery. As can be seen, there is a need for an improved blood fractionation tube design that is easy to use, results in samples with less contamination by surrounding fractions, yields more viable cells, and is more efficient overall.

### SUMMARY OF THE INVENTION

An hourglass shaped blood fractionation tube is sized and shaped to elongate or widen the PBMC layer of whole blood that has been centrifuged with a density gradient medium. Elongating or widening the PBMC layer allows technicians to harvest higher purity and volume PBMC samples versus samples harvested with a standard cylindrical blood fractionation tube. The hourglass shaped blood fractionation tube according to the present invention preferably includes a cap and can be used in conventional centrifuges and robotic pipetting stations.

### BRIEF DESCRIPTION OF THE DRAWINGS

FIG. 1 depicts a prior art blood fractionation tube containing a whole blood sample that has been centrifuged into three components;

FIG. 2 depicts a prior art blood fractionation tube containing a whole blood sample with a density gradient medium before and after centrifugation;

FIG. 3 is a top perspective view of a blood fractionation tube of the present invention;

FIG. 4 is a side view of the blood fractionation tube of FIG. 3;

FIG. 5 is a bottom perspective view of the blood fractionation tube of FIG. 3;

FIG. 6 is a top plan view of the blood fractionation tube of FIG. 3;

FIG. 7 is a bottom plan view of the blood fractionation tube of FIG. 3;

FIG. 8 is a side view of a blood fractionation tube of the present invention with whole blood and density gradient media prior to centrifugation; and

FIG. 9 is a side view of the blood fractionation tube of FIG. 8 that has been centrifuged and the resulting layers.

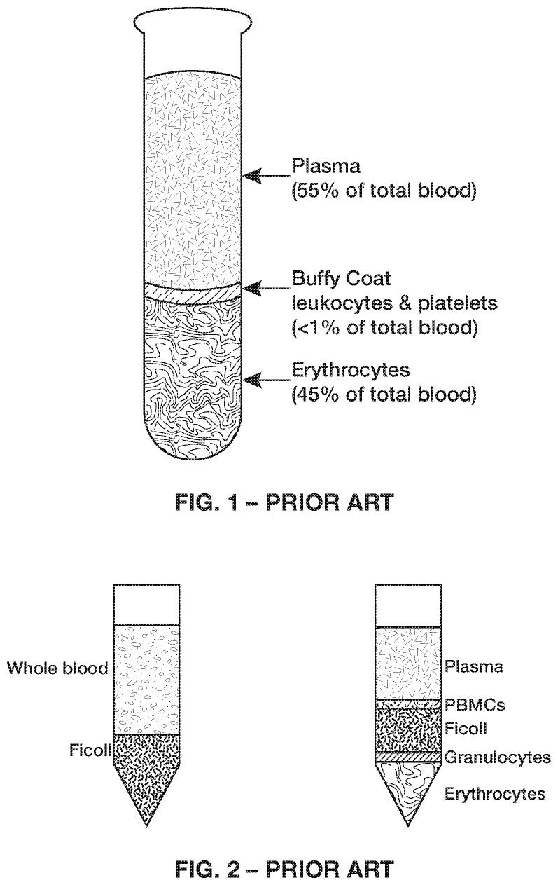

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The following structure numbers shall apply to the following structures among the various FIGS.:

10—tube system;

20—cap;

30—vessel;

31—threads;

32—upper cylindrical portion;

33—upper tapered portion;

35—neck;

37—lower tapered portion;

38—lower cylindrical portion;

39—bottom;

40—whole blood;

42—plasma;

44—PBMC's;

46—granulocytes;

48—erythrocytes; and

50—density gradient media.

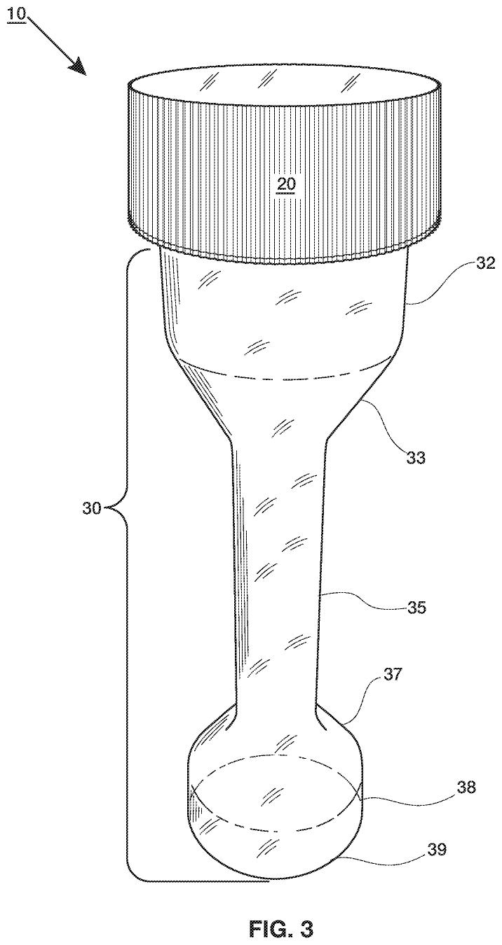

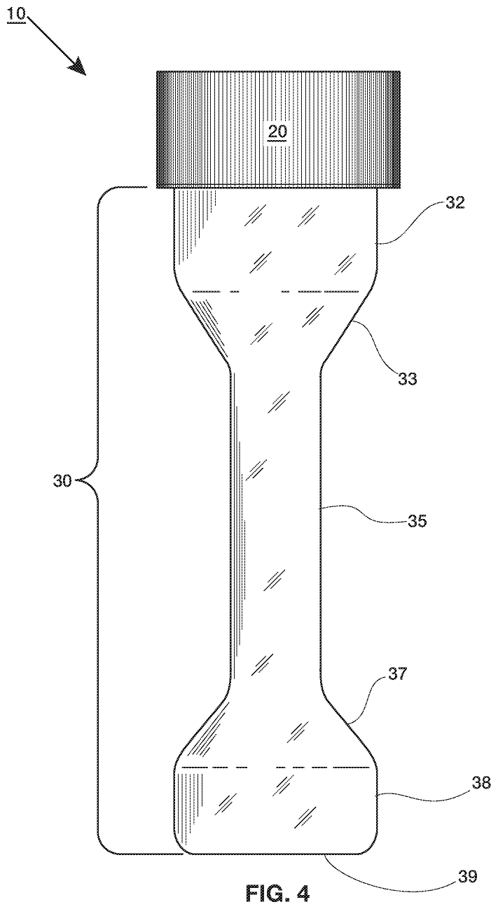

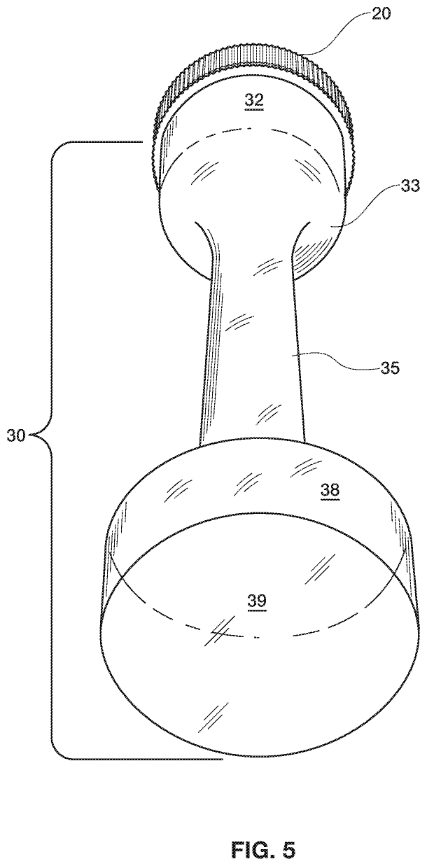

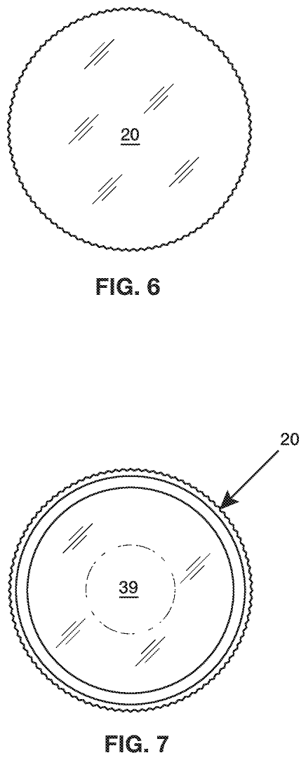

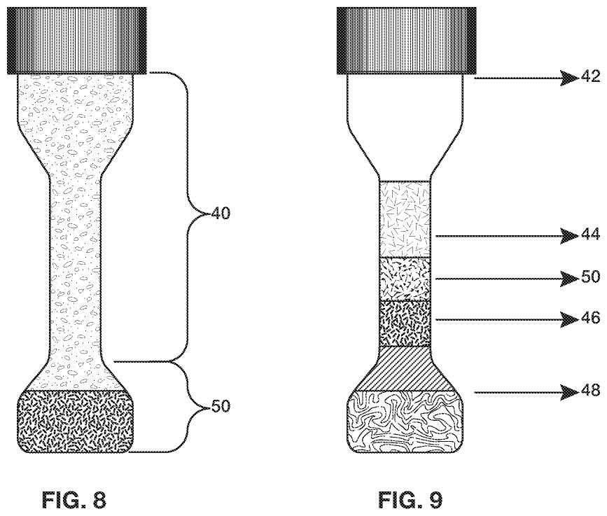

Referring to FIG. 3, tube system 10 generally includes elongated vessel 30 having cap 20. From cap downward, vessel 30 generally includes upper cylindrical portion 32, then upper tapered portion 33, then neck 35, then lower tapered portion 37, then lower cylindrical portion 38, and terminating in bottom 39. Although not shown, upper terminal end of upper cylindrical portion 32 defines an open end for ingress and egress of substances.

In a preferred embodiment vessel 30 has a volume of approximately 31 mL to approximately 36 mL, with approximately 11 mL to approximately 12 mL of total vessel volume attributed to upper cylindrical portion 32; approximately 6 mL to approximately 7 mL of total vessel volume attributed to upper tapered portion 33; approximately 4 mL to approximately 5 mL of total vessel volume attributed to neck 35; approximately 3 mL to approximately 4 mL of total vessel volume attributed to lower tapered portion 37; and approximately 7 mL to approximately 8 mL of total vessel volume attributed to lower cylindrical portion 38. The volume attributed to neck 35 is approximately 10% to approximately 17% of the total volume of vessel 30.

In a preferred embodiment the outer surface of upper cylindrical portion 32 defines threads 31 that releasably engage with cap 20.

The approximate dimensions of a preferred vessel are: 114.3 mm-116 mm total height; 30 mm height of upper cylindrical portion 32; 13 mm height of upper tapered portion 33; 50 mm height of neck 35; 10 mm of lower tapered portion 37; and 13 mm of lower cylindrical portion 38. The height of the elongated central neck is preferably approximately 38% to approximately 48% the total length of the vessel.

In a preferred embodiment the diameter of upper cylindrical portion 32 is approximately 28 mm; diameter of lower cylindrical portion 38 is approximately 11 mm; diameter of neck 35 is approximately 3.9 mm; and thickness of material is approximately 0.29 mm. The diameter of neck 35 is preferably approximately 9% to approximately 19% the diameter of said upper cylindrical portion.

In a preferred embodiment the vessel is constructed of known materials such as polypropylene, polystyrene, and/or glass and is manufactured by known methods such as injection molding and/or blow. Examples of automated systems that the tube is compatible with include Hamilton Microlab Star. Hamilton Microlab Vantage, Hamilton Microlab Nimbus, Beckman 15, Beckman 17 Tecan EVO and Tecan Fluent liquid handlers; and Beckman Coulter centrifuges.

In use, a technician dispenses approximately 4 mL to approximately 10 mL of a density gradient media such as FICOLL into vessel 30, adds approximately 10 mL to approximately 20 mL diluted whole uncoagulated blood, and seals the sample within vessel with cap 20. The ratio of the volume of blood to the volume of density gradient media is preferably approximately 1:1 to approximately 5:1.

The sample is centrifuged at 400 to 800 g at room temperature for 25 to 40 minutes with centrifugation brakes turned off. Following centrifugation, the PBMC layer is transferred to a 15 ml or 50 ml centrifugation tube using a transfer pipet or equivalent. The PBMC is diluted with a suitable wash solution to 14 ml or 40 ml for 15 ml or 50 ml centrifugation tubes, respectively, and centrifuged at 200 to 400 g at room temperature for 10 to 15 minutes, with the brakes turned on. After centrifugation, the supernatant is decanted and the PBMC pellet is broken up, then diluted in the media of choice, for example Phosphate-buffered saline.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. Rather, modifications may be made without departing from the spirit and scope of the invention as set forth in the following claims. An example of a modification is a different scale of tube size while keeping similar ratios in the dimensions. It should be understood that all specifications, unless otherwise stated or contrary to common sense, are +/−10%, and that ranges of values set forth inherently include those values, as well as all increments between. Also, “substantially” and similar language means “generally” but allowing for variations due to factors such as materials and manufacturing, and human interference.

What is claimed is:

1. A blood fractionation tube comprising:
a. an upper cylindrical portion terminating in an open end;
b. an upper tapered portion joined to said upper cylindrical portion;
c. an elongated central neck joined to said upper cylindrical portion;
d. a lower tapered potion joined to said elongated central neck;
e. a lower cylindrical portion joined to said lower tapered portion; and
f. a bottom abutting the terminal end of said lower cylindrical portion, wherein the diameter of said elongated central neck is approximately 9% to approximately 19% the diameter of said upper cylindrical portion.

2. The blood fractionation tube of claim 1 wherein the height of said elongated central neck is approximately 38% to approximately 48% the length spanning from said open end to said bottom.

3. The blood fractionation tube of claim 1 wherein the volume of said elongated central neck is approximately 10% to approximately 17% of the volume encompassed by said open end to said bottom.

4. The blood fractionation tube of claim 1 wherein the outer surface of said upper cylindrical portion defines a plurality of threads.

5. The blood fractionation tube of claim 4 wherein said plurality of threads releasably engage a cap.

6. A system for harvesting peripheral blood mononuclear cells (PBMCs) including:
a. an hourglass shaped blood fractionation tube having a total length and defining an elongated central neck having a neck length, said neck length approximately 38% to approximately 48% of said total length;
b. a volume of density gradient media; and
c. a volume of blood including a layer of PBMCs located within said elongated central neck.

7. The harvesting system of claim 6 wherein the ratio of said volume of blood to said volume of density gradient media is approximately 1:1 to approximately 5:1.

8. The harvesting system of claim 6 wherein said density gradient media is FICOLL.

9. The harvesting system of claim 6 wherein the volume of said elongated central neck is approximately 10% to approximately 17% of the total volume of said hourglass shaped blood fractionation tube.

10. A method of harvesting peripheral blood mononuclear cells (PBMCs) including the steps of:
a. dispensing a volume of density gradient media into an hourglass shaped blood fractionation tube having an elongated central neck;
b. dispensing a volume of blood into said hourglass shaped blood fractionation tube;
c. centrifuging said hourglass shaped blood fractionation tube; and
d. removing PBMCs from said elongated central neck.

11. The method of claim 10 wherein said step of dispensing a volume of blood into said hourglass shaped blood fractionation tube includes the step of dispensing a volume of diluted whole uncoagulated blood into said hourglass shaped blood fractionation tube.

12. The method of claim 10 wherein said step of centrifuging said hourglass shaped fractionation tube includes the step of centrifuging said hourglass shaped fractionation tube at approximately 400 g to approximately 800 g.

13. The method of claim 10 wherein said step of centrifuging said hourglass shaped fractionation tube includes the step of centrifuging said hourglass shaped fractionation tube for approximately 25 minutes to approximately 40 minutes.

14. The method of claim 10 further including the step of introducing said removed PBMC into a centrifugation tube.

15. The method of claim 14 further including the step of centrifuging said centrifugation tube.

16. The method of claim 15 further including the step of removing supernatant from said centrifugation tube.

17. The method of claim 10 wherein said step of removing PBMCs from said elongated central neck includes the step of pipetting.
